(19) United States
(12) Patent Application Publication
(10) Pub. No.: US 2026/0054288 A1
(43) Pub. Date: Feb. 26, 2026

(54) PREPARATION METHOD OF A WEAR-RESISTANT AND SCRATCH-RESISTANT BOARD

(71) Applicant: Välinge Innovation AB, Viken (SE)

(72) Inventor: Peitong CHAO, Tainan City (TW)

(73) Assignee: Välinge Innovation AB, Viken (SE)

(21) Appl. No.: 19/104,590

(22) PCT Filed: Aug. 22, 2023
(86) PCT No.: PCT/SE2023/050853

§ 371 Date: Feb. 18, 2025

(30) Foreign Application Priority Data
Aug. 24, 2022 (CN) 202211018213.8

(51) Int. Cl. B05D 5/06; B05D 3/06; B05D 3/12; B05D 7/00

(52) U.S. Cl. CPC B05D 5/06; B05D 3/067; B05D 3/12; B05D 7/576

(57) ABSTRACT

A preparation method of a wear-resistant and scratch-resistant board, such as floorboard, including a substrate, a printed pattern layer and a UV wear-resistant layer from bottom to top sequentially. The method includes the steps of applying a printed pattern layer on a substrate, coating a first UV coating on the printed pattern layer, thereby obtaining a UV coating layer, then scattering a wear-resistant and scratch-resistant powder on the UV coating layer, and then performing film pressing treatment, so that the wear-resistant and scratch-resistant powder is pressed into the UV coating layer to form a UV wear-resistant layer. The film pressing treatment includes pressing a release film against the UV coating layer comprising the wear-resistant and scratch-resistant powder.

### TECHNICAL FIELD

The present disclosure belongs to the technical field of boards, such as floorboards, and particularly relates to a wear-resistant and scratch-resistant board and a preparation method thereof.

### BACKGROUND

The wear resistance of existing floorboards, such as plastic floorboards, is usually improved by coating an ultraviolet curing paint (UV paint) added with aluminum oxide powder on a substrate. However, this method has the following problems: because an amount of aluminum oxide will affect the fluidity and coating uniformity of the UV paint, the amount of aluminum oxide added at a time should not be too much; and in order to obtain sufficient wear resistance, a general method is coating for several times in a small amount, which has a long coating time, a large amount of UV paint and a high production cost.

The Chinese patent CN 111644360 A discloses a forming method of a wear-resistant floorboard, which comprises the following steps of: coating an adhesive layer on a pattern of a printed layer of a substrate; spreading a transparent powder on a surface of the adhesive layer when the adhesive layer is not dried; coating a UV adhesive layer; and performing embossing when the UV adhesive layer is dry or semi-dry. This process overcomes the above-mentioned problems of uniformity and repeated coating, but there are still some shortcomings. Since the UV adhesive layer is coated after the transparent powder is spread, this treatment method makes the powder unable to be embedded in an interior of the paint layer and mostly exposed on a surface of the paint layer, resulting in a rough surface of the product. Even if the UV adhesive layer is coated again, the problem of rough surface cannot be completely overcome. In addition, the rough surface also affects a subsequent surface treatment in a certain extent, which limits the use of the board.

### SUMMARY

The present disclosure aims to solve at least one of the above technical problems in the prior art. Therefore, the present disclosure provides a wear-resistant and scratch-resistant board and a preparation method thereof. A wear-resistant layer with a smoother surface can be obtained by the preparation method of the present disclosure.

According to a first aspect of the present disclosure, a wear-resistant and scratch-resistant board, such as floorboard, is provided, which comprises a substrate, a printed pattern layer and a UV wear-resistant layer from bottom to top sequentially, wherein a wear-resistant and scratch-resistant powder is embedded in an upper surface of the UV wear-resistant layer, and the UV wear-resistant layer preferably has a flat upper surface. It should be understood that the wear-resistant and scratch-resistant powder preferably is concentrated near the upper surface of the UV wear-resistant layer, but are preferably not protruded or exposed on the surface of the UV wear-resistant layer, and may be located below the surface. Preferably, the upper surface is flat such that the surface has no convex and concave portions, such as micro-pores, and hence is essentially smooth.

In some embodiments of the present disclosure, the wear-resistant and scratch-resistant powder is pressed into the UV wear-resistant layer by film pressing treatment, such as membrane pressing treatment.

In some embodiments of the present disclosure, a transparent wear layer is further arranged between the printed pattern layer and the UV wear-resistant layer. The transparent wear layer may be a transparent film, and a material of the transparent wear layer may be determined according to a material of the substrate. For example, when the substrate comprises, or is made of polyvinyl chloride, PVC, the transparent wear layer may comprise, or may be made of, PVC, and when the substrate comprises, or is made of, polypropylene, PP, the transparent wear layer may comprise, or may be made of, PP. However, other combinations are equally conceivable, such as the substrate comprising polyethylene terephthalate, PET and the transparent wear layer comprising PET or PET glycol, PETG. The transparent wear layer can improve scratch resistance of the board.

The substrate may be provided as a substrate layer. In some embodiments of the present disclosure, the substrate is a single-layer or multi-layer board formed by extrusion or hot pressing. Optionally, a backing laying, such as a balancing layer, may be attached to, or may be part of, the substrate. The substrate may comprise, or may be made of, one or more of plastic, wood or an inorganic material, or any combination thereof.

The method may comprise applying a primer to the substrate. In some embodiments of the present disclosure, the printed pattern layer is applied by a method comprising: applying a plastic white film or a white coating to the substrate by printing, transfer-printing, spray-printing or digital-printing. The plastic white film may be applied to the substrate by lamination or adhesive bonding, or a patterned film may be laminated or bonded to the substrate directly.

In some embodiments of the present disclosure, the wear-resistant and scratch-resistant powder comprises, or is, at least one of an aluminum oxide powder, a glass powder, a silicon dioxide powder, or a nylon powder. The wear-resistant and scratch-resistant powder may be selected from an organic material or an inorganic material, and the inorganic material may be selected from, e.g., metal oxide or silicate.

In some embodiments of the present disclosure, a particle size of the wear-resistant and scratch-resistant powder is 500 nm to 20 μm. The size and type of the wear-resistant and scratch-resistant powder may be determined according to a performance requirement of the board. For example, the particle size of the wear-resistant and scratch-resistant powder may be 500 nm to 1 μm, 1 μm to 5 μm, 4 μm to 10 μm, 8 μm to 14 μm, 12 μm to 18 μm, or 15 μm to 20 μm.

In some embodiments of the present disclosure, an amount of the wear-resistant and scratch-resistant powder is 20 g/m² to 80 g/m².

According to a second aspect of the present disclosure, there is provided a preparation method of the wear-resistant and scratch-resistant board, such as floorboard, which comprises the following steps of: applying a printed pattern layer on a substrate, coating a first UV coating on the printed pattern layer, then scattering the wear-resistant and scratch-resistant powder on the UV coating layer, and then performing film pressing treatment, so that the wear-resistant and scratch-resistant powder is pressed into the UV coating layer to form a UV wear-resistant layer.

By means of the film pressing treatment, the pressing operation may become more controlled, for example since a film pressing device implementing the film pressing treatment may be more easily removed from the UV coating layer comprising the powder.

In some embodiments of the present disclosure, the preparation method further comprises forming a transparent wear layer on the printed pattern layer before coating the first UV coating.

In some embodiments of the present disclosure, a coating amount of the first UV coating is 10 g/m² to 120 g/m², such as 10 g/m² to 80 g/m² or 20 g/m² to 80 g/m², preferably 40 g/m² to 90 g/m².

In some embodiments of the present disclosure, the preparation method further comprises performing surface coating treatment on the UV wear-resistant layer.

In some embodiments of the present disclosure, the film pressing treatment is performed with a film pressing device. The film pressing device may be internally provided with a release film, preferably during the film pressing treatment. Alternatively, or additionally, the release film may be fed through the film pressing device, e.g., by means of rollers. Preferably, the release film is UV transmitting. Further, the release film may comprise PET or Teflon™, for example being made of PET or Teflon™ cloth. In some embodiments, the release film may comprise, or may be, a release paper, or it may comprise, or may be made of, silicone.

In some embodiments of the present disclosure, the surface coating treatment comprises: coating a second UV coating on the UV wear-resistant layer formed after the film pressing treatment, and performing surface matt treatment by an excimer lamp and a curing unit, such as a UV lamp. Thereby a second UV coating layer may be obtained.

In some embodiments of the present disclosure, the film pressing treatment may comprise embossing.

According to a third aspect of the present disclosure, there is provided a preparation method of a wear-resistant and scratch-resistant board, such as floorboard, comprising a substrate, a printed pattern layer and a UV wear-resistant layer from bottom to top sequentially. The method comprises the following steps of: applying a printed pattern layer on a substrate, coating a first UV coating on the printed pattern layer, thereby obtaining a UV coating layer, then scattering a wear-resistant and scratch-resistant powder on the UV coating layer, and then performing film pressing treatment, so that the wear-resistant and scratch-resistant powder is pressed into the UV coating layer to form a UV wear-resistant layer. Preferably, the film pressing treatment comprises pressing a release film against the UV coating layer comprising the wear-resistant and scratch-resistant powder.

Embodiments of the third aspect are largely analogous to those of the first and second aspects, whereby reference is made thereto. In addition, the following embodiments are conceivable:

The wear-resistant and scratch-resistant powder may be at least partially embedded, such as being entirely embedded, in an upper surface of the UV wear-resistant layer. By being partially embedded in the upper surface, some of the particles of the powder may be partly enclosed by the UV wear-resistant layer and partly open upwards. By being entirely embedded in the upper surface, the particles of the powder may be completely embedded by the UV wear-resistant layer, such that no particles are open upwards.

For example, at least 60%, preferably at least 80% of the particles of the powder may be entirely embedded in the upper surface.

The release film may be arranged in a film pressing device during the film pressing treatment.

The release film may be internally provided with the film pressing device, preferably during the film pressing treatment. Alternatively, or additionally, the release film may be fed through the film pressing device, e.g., by means of rollers.

The printed pattern layer may be applied by printing, transfer-printing, spray-printing or digital-printing.

The film pressing treatment may comprise embossing, such that the UV wear-resistant layer obtains an embossed upper surface. Thereby, the embossing may be performed simultaneously as the film pressing treatment.

In some embodiments, essentially an entirety of an upper surface of the UV wear-resistant layer may be subjected to the film pressing treatment. Thereby, all, or essentially all, of the particles of the powder may be pressed into the UV coating layer.

The release film may be UV transmitting. Throughout the present disclosure, the concept of a UV transmitting release film includes a UV semi-transmitting release film.

The method may comprise at least partially curing the UV coating layer, such as during the film pressing treatment. For example, the method may comprise at least partially curing the UV coating layer during the film pressing treatment by irradiating the UV coating layer through the UV transmitting release film by UV irradiation. By at least partially curing the UV coating layer, the release film may be even more easily removed from the UV coating layer comprising the powder.

The method may further comprise the step of curing the first UV coating. Preferably, the wear-resistant and scratch-resistant powder is scattered on the UV coating layer when the first UV coating not fully cured, such as being partially cured. The method may further comprise the step of fully curing the UV coating layer after performing the film pressing treatment.

According to a preferred embodiment of the present disclosure, the present disclosure has at least the following beneficial effects.

According to the present disclosure, after the UV coating is coated, the wear-resistant and scratch-resistant powder is scattered or sprayed on the surface of the UV coating layer to ensure uniform distribution of the powder, and then the wear-resistant and scratch-resistant powder is pressed into the UV coating layer through the film pressing treatment, preferably so that the wear-resistant and scratch-resistant powder is avoided from being exposed on the surface, the wear-resistant layer with a, preferably flat, and nearly smooth upper surface is formed, and a subsequent surface treatment is not affected. In the process, during the formation of the wear-resistant layer, the UV coating only needs to be coated once, which reduces a use amount and a coating time of the UV coating, thus reducing a cost. Moreover, a wear-resistant grade of the prepared board can reach above AC4, preferably according to an EN 13329-2000 standard.

According to a fourth aspect of the present disclosure, and more generally, the first UV coating and the UV coating layer in any of the first, second or third aspects may be replaced by a first coating and a coating layer, such as a first reactive polyurethane, PUR, coating and a PUR coating layer, respectively. Embodiments of the fourth aspect are largely analogous to those of the first, second and third aspects, whereby reference is made thereto.

### BRIEF DESCRIPTION OF THE DRAWINGS

The present disclosure is further described hereinafter with reference to the drawings and embodiments, wherein:

FIG. 1 schematically illustrates a flow chart of an embodiment of a preparation method.

FIG. 2 illustrates an embodiment of a film pressing device and its use.

FIG. 3 is a structural diagram of a wear-resistant floorboard prepared in accordance with Embodiment 1 of the present disclosure.

FIG. 4 is a structural diagram of a wear-resistant floorboard prepared in accordance with Embodiment 2 of the present disclosure.

FIG. 5 shows an alternative embodiment of a wear-resistant floorboard prepared in accordance with Embodiment 2 of the present disclosure.

### DETAILED DESCRIPTION

The concept and the generated technical effect of the present disclosure are clearly and completely described hereinafter with reference to embodiments to fully understand the objects, features and effects of the present disclosure. Obviously, the described embodiments are only some, but not all of the embodiments of the present disclosure, and based on the embodiments of the present disclosure, other embodiments obtained by those skilled in the art without going through any creative work all belong to the scope of protection of the present disclosure.

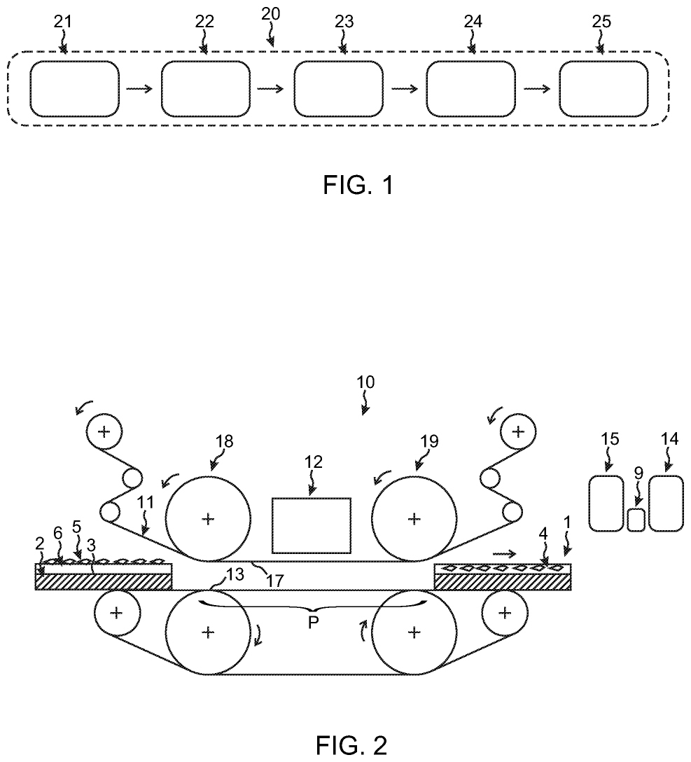

An embodiment of a method (Box 20) for preparing a wear-resistant and scratch-resistant board 1, such as floorboard, is illustrated in FIG. 1. First, a printed pattern layer 3 is applied on a substrate 2 (Box 21), such as by printing, transfer-printing, spray-printing or digital-printing. Optionally, the application may comprise applying a primer, such as a plastic white film 8a or a white coating 8b on the substrate 2.

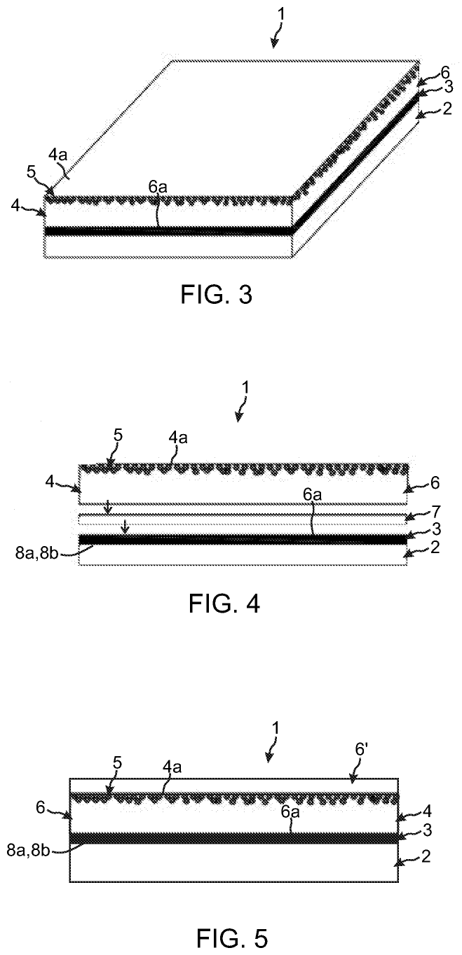

The printed pattern layer 3 is thereafter coated by a first UV coating (Box 22). Optionally, a UV primer coating layer 6a is applied on the printed pattern layer 3 before applying the first UV coating, preferably in an amount of 2-15 g/m², more preferably 6-10 g/m². The UV primer coating layer 6a may provide an improved adhesion between the first UV coating and the substrate 2. Optionally, the first UV coating is thereafter semi-cured and one or more additional UV coatings are applied on the first UV coating. A coating amount of the first UV coating, optionally including said one or more additional UV coatings, may be 10 g/m² to 120 g/m², such as 10 g/m² to 80 g/m² or 20 g/m² to 80 g/m², preferably 40 g/m² to 90 g/m². Thereby, a UV coating layer 6 is obtained from the first UV coating, optionally including said one or more additional UV coatings. Then a wear-resistant and scratch-resistant powder 5 is scattered on the UV coating layer 6 (Box 23), preferably uniformly, and a film pressing treatment is thereafter performed (Box 24), so that the powder 5 is pressed into the UV coating layer 6 to form a UV wear-resistant layer 4. Hence, the UV wear-resistant layer 4 comprises the powder 5 and the UV coating layer 6, and optionally the UV primer coating layer 6a, where the UV coating layer 6 comprises the first UV coating and optionally one or more additional UV coatings. In some embodiments, the film pressing treatment may be implemented by the film pressing device 10 in FIG. 2. The substrate 2 comprising the powder 5 scattered on the UV coating layer 6 may be fed to and through the film pressing device 10 by means of rollers, a conveyor belt, or similarly. Preferably, the powder 5 is scattered when the first UV coating, optionally including said one or more additional UV coatings, is not fully cured, preferably being uncured. The powder 5 may comprise, or may be, at least one of an aluminum oxide powder, a glass powder, a silicon dioxide, or a nylon powder. Thereby, the powder 5 becomes at least partially embedded, such as entirely embedded, in an upper surface 4a of the UV wear-resistant layer, cf. FIGS. 3, 4 and 5.

In some embodiments, an entirety of the upper surface 4a is subjected to the film pressing treatment. Thereby, essentially all of the particles in the powder may be pressed into the UV coating layer 6. For example, at least 60%, preferably at least 80% of the particles of the powder 5, such as essentially all of them, may be entirely embedded in the upper surface.

In some embodiments, the film pressing device 10 comprises at least one roller 18, 19, such as two rollers. For example, a distance between the roller(s) 18, 19 and a carrier 13 on which the substrate 2 is arranged may be fixed.

The substrate 2 comprising the powder 5 scattered on the UV coating layer 6 may be pressed in the film pressing treatment in a pressing zone P by at least one pressing operation, such as two pressing operations, for example by means of the at least one roller 18, 19, such as two rollers.

Preferably, the film pressing treatment comprises pressing a release film 11 against the UV coating layer 6 comprising the powder 5. In some embodiments, the release film 11 is UV transmitting, and the UV coating layer 6 may be at least partially cured during the film pressing treatment by irradiating the UV coating layer 6 through the UV transmitting release film by UV irradiation. For example, such a curing may be implemented by the UV curing device 12 in FIG. 2.

During the film pressing treatment, the release film 11 may be fed through the film pressing device 10 and/or it may be internally provided with the film pressing device 10. The release film 11 may be fed by at least one roller 18, 19. Moreover, during use of the film pressing device 10, the release film 11 may be arranged between the at least one roller 18, 19 and the carrier 13.

In some embodiments, a surface 17 of the release film 11 configured to face the substrate 2 during use may be essentially smooth such that the UV wear-resistant layer 4 may obtain an essentially flat upper surface 4a.

In some embodiments, a transparent wear layer 7 may be formed on the printed pattern layer 3 before coating the first UV coating, cf. FIG. 4.

The method may further comprise the step of fully curing the UV coating layer 6 after scattering the powder 5, such as by the curing device 12 and/or by a curing unit 14 located downstream of the pressing zone P, and after performing the film pressing treatment. Alternatively, a second UV coating may be coated on the UV wear-resistant layer 4 formed after the film pressing treatment using a coating device 15, thereby obtaining a second UV coating layer 6′ (Box 25), cf. FIGS. 2 and 5. Preferably, the second UV coating layer 6′ is applied in an amount of 5-15 g/m², more preferably 8-12 g/m². The second UV coating layer 6′ may be cured by the curing unit 14, such as UV lamp. In some embodiments, a surface coating treatment may be performed on the UV wear-resistant layer 4, for example by performing surface matt treatment by an excimer lamp 9 and/or the curing unit 14, such as the UV lamp.

In the above, any or all of the first and second UV coatings, and optionally said one or more additional UV coatings, may be an acrylic-based UV coating.

In some embodiments, the film pressing treatment comprises embossing, such that the UV wear-resistant layer 4 obtains an embossed upper surface 4a. For example, the release film 11 may comprise a textured surface 17 for providing the embossed surface.

### Embodiment 1

In this embodiment, a wear-resistant floorboard 1 was prepared. With reference to FIG. 3, the wear-resistant floorboard sequentially comprises a substrate 2, a printed pattern layer 3 and a UV wear-resistant layer 4 from bottom to top sequentially. Aluminum oxide powder 5 is embedded in an upper surface 4a of the UV wear-resistant layer, and the aluminum oxide powder is pressed into the UV wear-resistant layer by film pressing treatment.

The specific preparation method in this embodiment was as below.

A white film 8a was adhered to a PVC substrate 2, a pattern was spray-printed on the white film by digital printing to form the printed pattern layer 3, a first UV coating was coated on the printed pattern layer with a coating amount of 60 g/m², thereby obtaining a UV coating layer 6, then the aluminum oxide powder 5 was scattered on the UV coating layer 6 with an amount of 80 g/m², and then subjected to the film pressing treatment by a film pressing device 10 comprising a PET release film 11. During the film pressing treatment, the UV coating layer was cured, and the aluminum oxide powder was pressed into the UV coating layer to obtain the UV wear-resistant layer 4. Finally, a second UV coating was coated on an upper surface 4a of the UV wear-resistant layer (cf. FIG. 5), thereby obtaining a second UV coating layer 6′, and then subjected to surface matt treatment by an excimer lamp 9 and a curing unit 14 in the form of a UV lamp to obtain the wear-resistant floorboard 1.

According to an EN 13329-2000 standard, a wear-resistant grade of the wear-resistant floorboard was AC5.

### Embodiment 2

In this embodiment, a wear-resistant floorboard 1 was prepared. With reference to FIGS. 4 and 5, the wear-resistant floorboard comprises a substrate 2, a printed pattern layer 3, a transparent wear layer 7 and a UV wear-resistant layer 4 from bottom to top sequentially. Wear-resistant and scratch-resistant powder 5 is embedded in an upper surface 4a of the UV wear-resistant layer, and the wear-resistant and scratch-resistant powder is pressed into the UV wear-resistant layer by film pressing treatment.

The specific preparation method in this embodiment was as below.

A white film 8a was adhered to a PVC substrate 2, a pattern was spray-printed on the white film by digital printing to form the printed pattern layer 3, a PVC transparent wear layer 7 was formed on the printed pattern layer first, then a first UV coating was coated on the PVC transparent wear layer with a coating amount of 40 g/m², thereby obtaining a UV coating layer 6, then the aluminum oxide powder 5 was scattered on the UV coating layer 6 with an amount of 20 g/m², and then subjected to the film pressing treatment by a film pressing device 10 comprising a PET release film 11. During the film pressing treatment, the UV coating layer was cured, and the aluminum oxide powder was pressed into the UV coating layer to obtain the UV wear-resistant layer 4. Finally, a second UV coating was coated on an upper surface 4a of the UV wear-resistant layer (cf. FIG. 5), thereby obtaining a second UV coating layer 6′, and then subjected to surface matt treatment by an excimer lamp 9 and a curing unit 14 in the form of a UV lamp to obtain the wear-resistant floorboard 1. According to an EN 13329-2000 standard, a wear-resistant grade of the wear-resistant floorboard was AC4.

### Comparative Embodiment 1

In this comparative example, a wear-resistant floorboard was prepared, which was different from that in Embodiment 2 in that a second UV coating was directly coated after scattering the aluminum oxide powder, without a step of film pressing treatment.

The specific preparation method in this Comparative Embodiment was as below.

A white film was adhered to a PVC substrate, a pattern was spray-printed on the white film by digital printing to form the printed pattern layer, a first UV coating was coated on the printed pattern layer with a coating amount of 40 g/m², then the aluminum oxide powder was scattered on the UV coating layer with an amount of 20 g/m², then a second UV coating was coated on an upper surface of the UV wear-resistant layer, and then subjected to surface matt treatment by an excimer lamp and a UV lamp to obtain the wear-resistant floorboard. A wear-resistant grade of the wear-resistant floorboard was determined as AC4, while a surface of the wear-resistant floorboard was rough, which could not achieve an expected effect of surface matt treatment.

The embodiments of the present disclosure are described in detail with reference to the drawings above, but the present disclosure is not limited to the above embodiments, and various changes may also be made within the knowledge scope of those of ordinary skills in the art without departing from the purpose of the present disclosure. For example, it is understood that the rollers 18, 19 are exemplary and that the film pressing device 10 may comprise other types of pressing devices, such as press plates or conveyor belts. In addition, the embodiments of the present disclosure and the features in the embodiments may be combined with each other without conflict.

### Embodiments

Further aspects of disclosure are provided below. Embodiments, examples etc. of these aspects are largely analogous to the embodiments, examples, etc. as described above, whereby reference is made to the above for a detailed description.
Item 1. A wear-resistant and scratch-resistant board (1), such as floorboard, comprising a substrate (2), a printed pattern layer (3) and a UV wear-resistant layer (4) from bottom to top sequentially, wherein a wear-resistant and scratch-resistant powder (5) is embedded in an upper surface (4a) of the UV wear-resistant layer, and the UV wear-resistant layer preferably has a flat upper surface (4a).
Item 2. The wear-resistant and scratch-resistant board according to item 1, wherein a transparent wear layer (7) is further arranged between the printed pattern layer (3) and the UV wear-resistant layer (4).
Item 3. The wear-resistant and scratch-resistant board according to item 1 or 2, wherein the printed pattern layer (3) is applied by a method comprising: applying a plastic white film (8a) or a white coating (8b) to the substrate (2) by printing, transfer-printing, spray-printing or digital-printing.
Item 4. The wear-resistant and scratch-resistant board according to any of the preceding items, wherein the wear-resistant and scratch-resistant powder (5) is at least one of an aluminum oxide powder, a glass powder, a silicon dioxide or a nylon powder.
Item 5. A preparation method of the wear-resistant and scratch-resistant board (1), such as floorboard, according to any of the preceding items 1-4, comprising the following steps of: applying a printed pattern layer (3) on a substrate (2), coating a first UV coating on the printed pattern layer, then scattering the wear-resistant and scratch-resistant powder (5) on the UV coating layer, and then performing film pressing treatment, so that the wear-resistant and scratch-resistant powder is pressed into the UV coating layer to form a UV wear-resistant layer (4).
Item 6. The preparation method of the wear-resistant and scratch-resistant board according to item 5, further comprising: forming a transparent wear layer (7) on the printed pattern layer before coating the first UV coating.
Item 7. The preparation method of the wear-resistant and scratch-resistant board according to item 5 or 6, wherein a coating amount of the first UV coating is 20 g/m² to 80 g/m².
Item 8. The preparation method of the wear-resistant and scratch-resistant board according to any of the preceding items 5-7, further comprising: performing surface coating treatment on the UV wear-resistant layer (4).
Item 9. The preparation method of the wear-resistant and scratch-resistant board according to item 8, wherein the surface coating treatment comprises: coating a second UV coating on the UV wear-resistant layer (4) formed after the film pressing treatment, thereby obtaining a second UV coating layer (6′), and performing surface matt treatment by an excimer lamp (9) and a curing unit (14), such as a UV lamp.
Item 10. The preparation method of the wear-resistant and scratch-resistant board according to any of the preceding items 5-9, wherein the film pressing treatment is performed with a film pressing device (10) which is internally provided with a release film (11).
Item 11. The preparation method of the wear-resistant and scratch-resistant board according to any of the preceding items 5-10, wherein the film pressing treatment comprises embossing.

1. A preparation method of a wear-resistant and scratch-resistant board (1) comprising a substrate, a printed pattern layer and a UV wear-resistant layer from bottom to top sequentially, the method comprising the following steps of:
applying a printed pattern layer on a substrate,
coating a first UV coating on the printed pattern layer, thereby obtaining a UV coating layer,
then scattering a wear-resistant and scratch-resistant powder on the UV coating layer, and
then performing film pressing treatment, so that the wear-resistant and scratch-resistant powder is pressed into the UV coating layer to form a UV wear-resistant layer,
wherein the film pressing treatment comprises pressing a release film against the UV coating layer comprising the wear-resistant and scratch-resistant powder.

2. The preparation method according to claim 1, wherein the wear-resistant and scratch-resistant powder is at least partially embedded in an upper surface of the UV wear-resistant layer.

3. The preparation method according to claim 1, further comprising:
forming a transparent wear layer on the printed pattern layer before coating the first UV coating.

4. The preparation method according to claim 1, wherein a coating amount of the first UV coating is 10 g/m² to 120 g/m².

5. The preparation method according to claim 1, further comprising:
performing surface coating treatment on the UV wear-resistant layer.

6. The preparation method according to claim 5, wherein the surface coating treatment comprises:
coating a second UV coating on the UV wear-resistant layer formed after the film pressing treatment, thereby obtaining a second UV coating layer, and performing surface matt treatment by an excimer lamp and a curing unit.

7. The preparation method according claim 1, wherein the film pressing treatment comprises pressing a film pressing device against the UV coating layer.

8. The preparation method according to claim 1, wherein the release film is arranged in a film pressing device during the film pressing treatment.

9. The preparation method according to claim 1, wherein the release film is internally provided with the film pressing device and/or wherein the release film is fed through the film pressing device.

10. The preparation method according to claim 1, wherein the printed pattern layer is applied by printing, transfer-printing, spray-printing or digital-printing.

11. The preparation method according to claim 1, wherein the printed pattern layer is applied by a method comprising:
applying a plastic white film or a white coating to the substrate by printing, transfer-printing, spray-printing or digital-printing.

12. The preparation method according to claim 1, wherein the wear-resistant and scratch-resistant powder comprises at least one of an aluminum oxide powder, a glass powder, a silicon dioxide or a nylon powder.

13. The preparation method according to claim 1, wherein the film pressing treatment comprises embossing, such that the UV wear-resistant layer obtains an embossed upper surface.

14. The preparation method according to claim 1, wherein the UV wear-resistant layer has a flat upper surface.

15. The preparation method according to claim 1, wherein essentially an entirety of an upper surface of the UV wear-resistant layer is subjected to the film pressing treatment.

16. The preparation method according to claim 1, wherein the release film is UV transmitting, and wherein the method comprises at least partially curing the UV coating layer during the film pressing treatment by irradiating the UV coating layer through the UV transmitting release film by UV irradiation.

17. The preparation method according to claim 1, wherein the wear-resistant and scratch-resistant powder is scattered on the UV coating layer when the first UV coating is not fully cured, and wherein the method further comprises the step of fully curing the UV coating layer after performing the film pressing treatment.
